(19) United States
(12) Patent Application Publication
(10) Pub. No.: US 2010/0074551 A1
(43) Pub. Date: Mar. 25, 2010

(54) LEARNING-BASED PARTIAL DIFFERENTIAL EQUATIONS FOR COMPUTER VISION

(75) Inventors: Zhouchen Lin, Beijing (CN); Wei Zhang, Hongkong (CN)

Correspondence Address: PERKINS COIE LLP/MSFT, P. O. BOX 1247, SEATTLE, WA, 98111-1247, US

(73) Assignee: Microsoft Corporation, Redmond, WA (US)

(21) Appl. No.: 12/235,488

(22) Filed: Sep. 22, 2008

(51) Int. Cl. G06K 9/40

(52) U.S. Cl. 382/264

(57) ABSTRACT

Partial differential equations (PDEs) are used in the invention for various problems in computer the vision space. The present invention provides a framework for learning a system of PDEs from real data to accomplish a specific vision task. In one embodiment, the system consists of two PDEs. One controls the evolution of the output. The other is for an indicator function that helps collect global information. Both PDEs are coupled equations between the output image and the indicator function, up to their second order partial derivatives. The way they are coupled is suggested by the shift and rotational invariance that the PDEs should hold. The coupling coefficients are learnt from real data via an optimal control technique. The invention provides learning-based PDEs that make a unified framework for handling different vision tasks, such as edge detection, denoising, segementation, and object detection.

### BACKGROUND

Applications in the software industry have used partial differential equations (PDEs) for computer vision and image processing. However, this technique did not draw much attention until the introduction of the concept of scale space by Koenderink and Witkin in the 1980s. Further, Perona and Malik's work on anisotropic diffusion increased interest on PDE based methods. Currently, PDEs have been successfully applied to many problems in computer vision and image processing, e.g., denoising, enhancement, inpainting, segmentation, stereo, and optical flow computation.

There are generally two methods of designing PDEs. In the first kind of method, PDEs are written down directly, based on some mathematical understanding on the properties of the PDEs (e.g., anisotropic diffusion, shock filter, and curve evolution based equations). The second type basically defines energy function first, which collects the wish list of the desired properties of the output image, and then derives the evolution equations by computing the Euler-Lagrange variation of the energy function. Both methods require the choosing of appropriate functions and predicting the final effect of composing these functions such that the obtained PDEs roughly meet the goals. Either way, intuition is heavily relied upon, e.g., smoothness of edge contour and surface shading, on the vision task. Such intuition should easily be quantified and be described using the operators (e.g., gradient and Laplacian), functions (e.g., quadratic and square root functions) and numbers (e.g., 0.5 and 1) that people are familiar with. As a result, the designed PDEs can only reflect very limited aspects of a vision task (hence are not robust in handling complex situations in real applications) and also appear rather artificial. If people do not have enough intuition on a vision task, they may have difficulty in acquiring effective PDEs. For example, can we have a PDE (or a PDE system) for object detection (FIG. 1) that detects the object region if the object is present and does not respond if the object is absent? We believe that this is a big challenge to human intuition because it is hard to describe an object class, which may have significant variation in shape, texture, and pose. Although there has been much work on PDE-based image segmentation, the basic philosophy is always to follow the strong edges of the image and also require the edge contour to be smooth. Without using additional information to judge the content, the artificial PDEs always output an “object region” for any non-constant image. In short, current PDE design methods greatly limit the applications of PDEs to wider and more complex scopes.

### BRIEF DESCRIPTION OF THE DRAWINGS

FIG. 1 illustrates an example of objects that can be identified by the methods of the present invention.

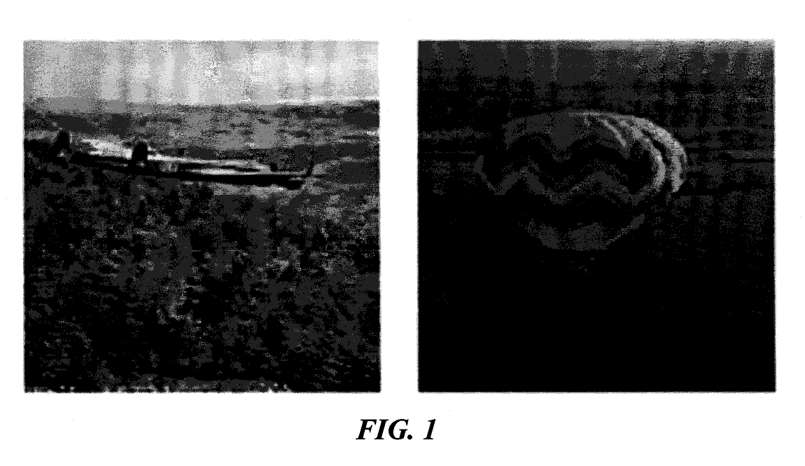

FIG. 2 illustrates partial results on image denoising method.

FIG. 3 illustrates partial results on image edge detection.

FIG. 4 illustrates an example of the training image and the ground truth object mask for each data set.

FIG. 5 illustrates an example of the training image and the ground truth object mask for each data set.

FIG. 6 illustrates results of a method for detecting butterflies.

FIG. 7 illustrates results of a method for detecting planes.

FIG. 8 illustrates results of a method for detecting objects without imposing constraints on the coefficients.

FIG. 9 illustrates results of a number of segmenting examples.

FIG. 10 illustrates more examples of objects that can be identified by the methods of the present invention.

FIG. 11 illustrates yet more examples of objects that can be identified by the methods of the present invention.

### DETAILED DESCRIPTION

The claimed subject matter is described with reference to the drawings, wherein like reference numerals are used to refer to like elements throughout. In the following description, for purposes of explanation, numerous specific details are set forth in order to provide a thorough understanding of the subject innovation. It may be evident, however, that the claimed subject matter may be practiced without these specific details. In other instances, well-known structures and devices are shown in block diagram form in order to facilitate describing the subject innovation.

As utilized herein, terms “component,” “system,” “data store,” “evaluator,” “sensor,” “device,” “cloud,” ‘network,” “optimizer,” and the like are intended to refer to a computer-related entity, either hardware, software (e.g., in execution), and/or firmware. For example, a component can be a process running on a processor, a processor, an object, an executable, a program, a function, a library, a subroutine, and/or a computer or a combination of software and hardware. By way of illustration, both an application running on a server and the server can be a component. One or more components can reside within a process and a component can be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter. Moreover, the word “exemplary” is used herein to mean serving as an example, instance, or illustration. Any aspect or design described herein as “exemplary” is not necessarily to be construed as preferred or advantageous over other aspects or designs.

Human vision is a result of an enormous number of connected neurons of the human brain and the behavior of a single neuron can be described by ordinary differential equations. So it is expected that the human visual system (HVS) can be modeled by a system of PDEs and does not rely on whether the HVS really obeys the PDEs we acquire. Rather, as long as the output of our PDEs approximates those of the HVS, we consider that the modeling is effective.

In accordance with aspects of the present invention, a general framework for learning PDEs to accomplish a specific vision task is disclosed. The vision task will be exemplified by a number of input-output image pairs, rather than relying on any form of human intuition. The learning algorithm is based on the theory of optimal control governed by PDEs. It is assumed that the system consists of two PDEs: One controls the evolution of the output. The other is for an indicator function that helps collect global information. The PDEs are shift and rotationally invariant, thus they must be functions of fundamental differential invariants. We assume that the PDEs are linear combinations of fundamental differential invariants up to second order. However, more complex forms of the PDEs are possible. The coupling coefficients are learned from real data via the optimal control technique.

In past applications applying optimal control to computer vision and image processing was used for minimizing known energy functions for various tasks, including shape evolution, morphology, optical flow, and shape from shading, where the target functions fulfill known PDEs. And the output functions are the desired. Moreover, the evolutionary PDE is a steepest descent version of the procedure of finding the minimizer function. Conversely, one goal of the present invention is to determine a PDE system which is unknown at the beginning and the coefficients of the PDEs are the desired. The learned evolutionary PDEs are to control the evolution of the output. They are not for optimization. Other past applications learn a spatially dependent and temporally varying blurring kernel to approximate the anisotropic diffusion equation with an integral equation that convolves the input image with the kernel. However, this work is targeted at diffusion equations only and this problem can be easily described in the language of mathematics.

In principle, the learning-based PDEs learn a high dimensional mapping function between the input and the output. Many learning/approximation methods, e.g., neural networks, can also fulfill this purpose. However, learning-based PDEs are fundamentally different from those methods in that those methods learn explicit mapping functions ƒ:O=ƒ(I), where I is the input and O is the output, while our PDEs learn implicit mapping functions φ:φ(I,O)=0. Given the input I, we solve for the output O. The input dependent weights for the outputs, due to the coupling between the output and the indicator function that evolves from the input, makes our learning-based PDEs more adaptive to tasks and also requiring fewer training samples. For example, we only used 60 training image pairs for all our experiments. Such a number is not possible for traditional methods, considering the high dimensionality of the images. Moreover, backed by the rich theories on PDEs, it is possible to better analyze some properties of interest of the learnt PDEs. For example, the theory of differential invariants plays the key role in suggesting the form of our PDEs.

The following sections of the disclosure include: an introduction of the optimal control theory, a description of the framework of learning-based PDEs, including the form of PDEs, the objective functional, and a description on how to control the blowup of the output. Following that data is presented to the effectiveness and versatility of our learning-based PDEs by four vision tasks.

In this section, we sketch the existing theory of optimal control governed by PDEs that we will borrow. There are many types of such problems. For illustrative purposes, we only focus on the following distributed optimal control problem:

minimize J(ƒ,u), where u ε U controls ƒ via the following PDE: (1)

$$\{ \begin{matrix}{f}_{t} = L ( 〈 u 〉 , 〈 f 〉 ) , & ( x , t ) ∈ Q , \\ f = 0 , & ( x , t ) ∈ Γ , \\ f {\vert}_{t = 0} = {f}_{0} , & x ∈ Ω ,\end{matrix} \qquad ( 2 )$$

TABLE 1
Notations

| x | (x, y), spatial variable | t | temporal variable |
|---|---|---|---|
| Ω | an open region of R² | ∂Ω | boundary of Ω |
| Q | Ω × (0, T) | Γ | ∂Ω × (0, T) |
| W | Ω, Q, Γ, or (0, T) | (f, g)_{w} | ${\int }_{W} fgdW$ |
| ∇f | gradient of f | H_{f} | Hessian of f |
| [symbol] | {0, x, y, xx, xy, yy, . . . } | \|p\|, p ∈ [symbol] ∪ {t} | the length of string p |
| $\frac{{\partial }^{\vert p \vert} f}{\partial p} , p ∈ ⋃ \{ t \}$ | $f , \frac{\partial f}{\partial t} , \frac{\partial f}{\partial x} , \frac{\partial f}{\partial y} , \frac{{\partial }^{2} f}{\partial {x}^{2}} , \frac{{\partial }^{2} f}{\partial x \partial y} , … , when p = 0 , t , x , y , xx , xy , …$ | | |
| fₚ, p ∈ [symbol] ∪ {t} | $\frac{{\partial }^{\vert p \vert} f}{\partial p}$ | <f> | {fₚ\|p ∈ [symbol] } |

| | |
|---|---|
| P[f] | $\begin{matrix}the action of differential operator P on function f , i . e . , if \\ P = {a}_{0} + {a}_{10} \frac{\partial }{\partial x} + {a}_{01} \frac{\partial }{\partial y} + {a}_{20} \frac{{\partial }^{2}}{\partial {x}^{2}} + {a}_{11} \frac{{\partial }^{2}}{\partial x \partial y} + … , then \\ P \vert f \vert = {a}_{0} f + {a}_{10} \frac{\partial f}{\partial y} + {a}_{01} \frac{\partial f}{\partial y} + {a}_{20} \frac{{\partial }^{2} f}{\partial {x}^{2}} + {a}_{11} \frac{{\partial }^{2} f}{\partial x \partial y} + …\end{matrix}$ |
| L_{<f>} (<f>, . . . ) | $the differential operator {\sum }_{} \frac{\partial L}{\partial {f}_{p}} \frac{{\partial }^{\vert p \vert}}{\partial p} associated to function L ( 〈 f 〉 , … )$ |

in which J is a functional, U is the admissible control set, and L(·) is a smooth function. The meaning of the notations can be found in Table 1. To present the basic theory, some definitions are necessary.

Gâteaux derivative is an analogy and also extension of usual function derivative. Suppose J(ƒ) is a functional that maps a function ƒ on region W to a real number. Its Gâteaux derivative (if it exists) is defined as the function ƒ* on W that satisfies:

$$( {f}^{*} , δ f ) w = {lim}_{ɛ \to 0} \frac{J ( f + ɛ \cdot δ f ) - J ( f )}{ɛ}$$

for all admissible perturbations δƒ of ƒ. We may write ƒ* as

$$\frac{DJ}{Df} .$$

For example, it W=Q and J(ƒ)=½∫_{Ω}[ƒ(x, T)−\tilde{ƒ}(x)]²dx, then

$$\begin{matrix}J ( f + ɛ \cdot δ f ) - J ( f ) = \frac{1}{2} {\int }_{Ω} {[ f ( x , T ) + ɛ \cdot δ f ( x , T ) - \tilde{f} ( x ) ]}^{2} d Ω - \\ \frac{1}{2} {\int }_{Ω} {[ f ( x , T ) - \tilde{f} ( x ) ]}^{2} d Ω \\ = ɛ \cdot {\int }_{Ω} [ f ( x , T ) - \tilde{f} ( x ) ] δ f ( x , T ) d Ω + o ( ɛ ) \\ = ɛ \cdot {\int }_{Ω} \{ [ f ( x , t ) - \tilde{f} ( x ) ] δ f ( x , t ) d Q + o ( ɛ ) \}\end{matrix}$$

where δ(·) is the Dirac function. Not to confuse this with the perturbations of functions. Therefore,

$$\frac{DJ}{Df} = [ f ( x , t ) - \tilde{f} ( x ) ] δ ( t - T )$$

The adjoint operator P* of a linear differential operator P acting on functions on W is one that satisfies:

(P*[ƒ], g)_{w}=(ƒ, P[g])_{w},

for all ƒ and g that are zero on ∂W and are sufficiently smooth. The adjoint operator can be found by integration by parts, i.e., using the Green's formula. For example, the adjacent operator of

$$P = \frac{{\partial }^{2}}{\partial {x}^{2}} + \frac{{\partial }^{2}}{\partial {y}^{2}} + \frac{\partial }{\partial x} is {P}^{*} = \frac{{\partial }^{2}}{\partial {x}^{2}} + \frac{{\partial }^{2}}{\partial {y}^{2}} + \frac{\partial }{\partial x}$$

because by Green's formula,

$$\begin{matrix}{( f , L [ g ] )}_{Ω} = {\int }_{Ω} f ( {g}_{xx} + {g}_{yy} + {g}_{x} ) d Ω \\ = {\int }_{Ω} g ( {f}_{xx} + {f}_{yy} + {f}_{x} ) d Ω + {\int }_{\partial Ω} [ ( {fg}_{x} + fg + {f}_{x} g ) \\ cos ( N , x ) + ( {fg}_{y} - {f}_{y} g ) cos ( N , y ) ] d S \\ = {\int }_{Ω} ( {f}_{xx} + {f}_{yy} + {f}_{x} ) g d Ω ,\end{matrix}$$

where N is the outward normal of Ω and we have used that ƒ and g vanish on ∂Ω.

The following is a description on techniques for finding the Gâteaux derivative via the adjoint equation. Problem (1)-(2) can be solved if we can find the Gâteaux derivative of J w.r.t. the control u: we may find the optimal control u via steepest descent.

Suppose

$$J ( f , u ) = {\int }_{Q} g ( 〈 u 〉 , 〈 f 〉 ) d Q$$

where g is a smooth function. Then it can be proved that

$$\frac{DJ}{Du} = {L}_{〈 u 〉}^{*} ( 〈 u 〉 , 〈 f 〉 ) [ ϕ ] + {g}_{〈 u 〉}^{*} ( 〈 u 〉 , 〈 f 〉 ) [ 1 ] \qquad ( 3 )$$

where [symbol] and [symbol] are the adjoint operators of [symbol] and [symbol] (see Table 1 for the notations), respectively, and the adjoint function φ is the solution to the following PDE:

$$\{ \begin{matrix}- {ϕ}_{t} - {L}_{〈 f 〉}^{*} ( 〈 u 〉 , 〈 f 〉 ) [ ϕ ] = {g}_{〈 f 〉}^{*} ( 〈 u 〉 , 〈 f 〉 ) [ 1 ] , & ( x , t ) ∈ Q , \\ ϕ = 0 , & ( x , t ) ∈ Γ , \\ ϕ {\vert}_{t = T} = 0 , & x ∈ Ω ,\end{matrix} \qquad ( 4 )$$

which is called the adjoint equation of (2).

The adjoint operations above make the deduction of the Gâteaux derivative non-trivial. As an equivalence, a more intuitive way is to introduce a Lagrangian function:

$$\tilde{J} ( f , u ; ϕ ) = J ( f , u ) + {\int }_{Q} ϕ [ {f}_{t} - L ( 〈 u 〉 , 〈 f 〉 ) ] d Q , \qquad ( 5 )$$

where the multiplier φ is exactly the adjoint function. Then one can see that the PDE constraint (2) is exactly the first optimality condition:

$$\frac{d \tilde{J}}{d ϕ} = 0 ,$$

where

$$\frac{d \tilde{J}}{d ϕ}$$

s the partial Gâteaux derivative of J w.r.t. φ, and verify that the adjoint equation is exactly the second optimality condition:

$$\frac{d \tilde{J}}{d f} = 0.$$

And finally one can have that

$$\frac{DJ}{Du} = \frac{d \tilde{J}}{d u} , \qquad ( 6 )$$

### So

$$\frac{DJ}{Du} = 0$$

is equivalent to the third optimality condition:

$$\frac{d \tilde{J}}{d f} = 0.$$

In the above description we assume ƒ, u, and φ are independent functions.

As a result, we can use the definition of Gâteaux derivative to perturb ƒ and u in \tilde{J} and utilize Green's formula to pass the derivatives on the perturbations δƒ and δu other functions, in order to obtain the adjoint equation and

$$\frac{DJ}{Du} .$$

By concepts of the present invention, the above theory can be extended to systems of PDEs and multiple control functions.

Now we present our framework of learning PDE systems from training images. As preliminary work, we assume that our PDE system consists of two PDEs. One is for the evolution of the output image O. And the other is for the evolution of an indicator function ρ. The goal of introducing the indicator function is to collect large scale information in the image so that the evolution of O can be correctly guided. This idea is inspired by what is known in the art as an edge indicator. So our PDE system can be written as:

$$\{ \begin{matrix}{O}_{t} = {L}_{O} ( a 〈 O 〉 , 〈 ρ 〉 ) , & ( x , t ) ∈ Q , \\ O = 0 , & ( x , t ) ∈ Γ , \\ O {\vert}_{t = 0} = {O}_{0} , & x ∈ Ω , \\ {ρ}_{t} = {L}_{ρ} ( b 〈 ρ 〉 , 〈 O 〉 ) , & ( x , t ) ∈ Q , \\ ρ = 0 , & ( x , t ) ∈ Γ , \\ ρ {\vert}_{t = 0} = {ρ}_{0} , & x ∈ Ω ,\end{matrix} \qquad ( 7 )$$

where Ω is the rectangular region occupied by the input image I, T is the time that the HVS is expected to finish the visual information processing and output the results, and O₀ and ρ₀ are the initial functions of O and ρ, respectively. For computational issues and the ease of mathematical deduction, I will be padded with zeros of several pixels width around it. And as we can change the unit of time, it is harmless to fix T=1. L₀ and L_{ρ} are smooth functions. a={aᵢ} and b={bᵢ} are sets of functions defined on Q that are used to control the evolution of O and ρ, respectively. The forms of L₀ and L_{ρ} will be discussed below.

TABLE 2
Shift and rotationally invariant fundamental differential invariants
up to second order.

| i | invᵢ(ρ, O) |
|---|---|
| 0, 1, | 1, ρ, O |
| 2 | |
| 3, 4, | \|\|∇ρ\|\|² = ρₓ² + ρ_{y}², (∇ρ)^{t} ∇O = pₓOₓ + p_{y}O_{y}, \|\|∇O\|\|² = Oₓ² + O_{y}² |
| 5 | |
| 6, 7 | tr(H_{ρ}) = ρₓₓ + ρ_{yy}, tr(H_{O}) = Oₓₓ + O_{yy} |
| 8 | (∇ρ)^{t} H_{ρ}∇ρ = ρₓ²ρₓₓ² + 2ρₓρ_{y}ρ_{xy}² + ρ_{y}²ρ_{yy}² |
| 9 | (∇ρ)^{t} H_{O}∇ρ = ρₓ²ρₓₓ² + 2ρₓρ_{y}O_{xy}² + ρ_{y}²O_{yy}² |
| 10 | (∇ρ)^{t} H_{ρ}∇O = ρₓOₓρₓₓ + (ρ_{y}Oₓ + ρₓO_{y})ρ_{xy} + ρ_{y}O_{y}ρ_{yy} |
| 11 | (∇ρ)^{t} H_{O}∇O = ρₓOₓOₓₓ + (ρ_{y}Oₓ + ρₓO_{y})O_{xy} + ρ_{y}O_{y}O_{yy} |
| 12 | (∇O)^{t} H_{ρ}∇O = Oₓ²ρₓₓ + 2OₓO_{y}ρ_{xy} + O_{y}²ρ_{yy} |
| 13 | (∇O)^{t} H_{O}∇O = Oₓ²Oₓₓ + 2OₓO_{y}O_{xy} + O_{y}²O_{yy} |
| 14 | tr(H_{ρ}²) = ρₓₓ² + 2ρ_{xy}² + ρ_{yy}² |
| 15 | tr(H_{ρ}H_{O}) = ρₓₓOₓₓ + 2ρ_{xy}O_{xy} + ρ_{yy}O_{yy} |
| 16 | tr(H_{O}²) = Oₓₓ² + 2O_{xy}² + O_{yy}² |

### 3.1 Forms of PDEs

The space of all PDEs is of infinite dimension. To find the right one, we start with the properties that our PDE system should have, in order to narrow down the search space. We notice that for most vision tasks HVS is shift and rotationally invariant, i.e., when the input image is shifted or rotated, the output image is also shifted or rotated by the same amount. So we require that our PDE system is shift and rotationally invariant.

According to the differential invariants theory, L_{O} and L_{ρ} must be functions of the fundamental differential invariants under the groups of translation and rotation. The fundamental differential invariants are invariant under shift and rotation and other invariants can be written as their functions. The set of fundamental differential invariants is not unique, but different sets can express each other. We should choose invariants in the simplest form in order to ease mathematical deduction and analysis and numerical computation. Fortunately, for shift and rotational invariance, the fundamental differential invariants can be chosen as polynomials of the partial derivatives of the function. We list those up to second order in Table 2. We add the constant function “1” for convenience of the mathematical deductions in the sequel. As ∇ƒ and H_{ƒ} change to R∇ƒ and RH_{ƒ}R^{t}, respectively, when the image is rotated by a matrix R, it is easy to check the rotational invariance of those quantities. In the sequel, we shall use inv (ρ, O), i=0, 1, . . . , 16, to refer to them in order. Note that those invariants are ordered with ρ going before O. We may reorder them with O going before. In this case, the i-th invariant will be referred to as invᵢ (O, ρ).

On the other hand, for L_{O} and L_{ρ} to be shift invariant, the control functions aᵢ and bᵢ must be independent of x, i.e., they must be functions of t only. So the simplest choice of functions L_{O} and L_{ρ} is the linear combination of these differential invariants, leading to the following forms:

$${L}_{O} ( a , 〈 O 〉 , 〈 ρ 〉 ) = {\sum }_{j = 0}^{16} {a}_{j} ( t ) {inv}_{j} ( ρ , O ) , \\ {L}_{ρ} ( b , 〈 ρ 〉 , 〈 O 〉 ) = {\sum }_{j = 0}^{16} {b}_{j} ( t ) {inv}_{j} ( O , ρ ) . \qquad ( 8 )$$

Note that the HVS may not obey PDEs in such a form. However, we are NOT to discover how the real HVS works. Rather, we treat the HVS as a black box. We only care whether the final output of our PDE system, i.e., O(x,1), can approximate that of the real HVS. For example, although O₁(x,t)=∥x∥² sin t and O₂(x,t)=(∥x∥²+(1−t)∥x∥)(sin t+t(1−t)∥x∥³) are very different functions, they initiate from the same function at t=0 and also settle down at the same function at time t=1. So both functions fit our needs and we need not care whether the system obeys either function. Currently we only limit our attention to second order PDEs because most of the PDE theories are of second order and most PDEs arising from engineering are also of second order. It will pose difficulty in theoretical analysis if higher order PDEs are considered. Nonetheless, as L_{O} and L_{ρ} are actually highly nonlinear and hence the dynamics of Equation (7) can be complex, they are already complex enough to approximate many vision tasks in our experiments, as will be described below.

Given the forms of PDEs shown in Equation (8), we have to determine the coefficient functions aⱼ(t) and bⱼ(t). We may prepare training samples (Iₘ, Õₘ), where Iₘ is the input image and Õₘ is the expected output image, m=1, 2, . . . , M, and compute the coefficient functions that minimize the following functional:

$$J ( {\{ {O}_{m} \}}_{m = 1}^{M} , {\{ {a}_{j} \}}_{j = 0}^{16} , {\{ {b}_{j} \}}_{j = 0}^{16} ) = \frac{1}{2} {\sum }_{m = 1}^{M} {\int }_{Ω} {[ {O}_{m} ( x , 1 ) - {\tilde{Q}}_{m} ( x ) ]}^{2} d Ω + \frac{1}{2} {\sum }_{j = 0}^{16} {λ}_{j} {\int }_{0}^{1} {a}_{j}^{2} ( t ) d t + \frac{1}{2} {\sum }_{j = 0}^{16} {μ}_{j} {\int }_{0}^{1} {b}_{j}^{2} ( t ) d t \qquad ( 9 )$$

where Oₘ(x, 1) is the output image at time t=1 computed from Equation (7) when the input image is Iₘ, and λⱼ and μⱼ are positive weighting parameters. The first term requires that the final output of our PDE system should be close to the ground truth. The second and the third terms are for regularization so that the optimal control problem is well posed, as there may be multiple minimizers for the first term. The regularization is important, particularly when the training samples are limited.

Then we may compute the Gâteaux derivative

$$\frac{DJ}{{Da}_{j}} and \frac{DJ}{{Db}_{j}}$$

of J w.r.t. aⱼ and bⱼ using the theory described above. Consequently, the optimal aⱼ and bⱼ can be computed by steepest descent.

The following section describes the boundesness of outputs. In our experiments, we were often obsessed by the problem that the output O blew up when applying the learnt PDE system to a new test image. This forced us to consider the problem: under what conditions the learnt PDE system guarantees a bounded solution? Here we apply a boundedness theorem in non-linear parabolic equation theory to find the constraints on the coefficients aⱼ(t) and bⱼ(t). We prove that

Theorem 1. Both O and p are bounded if:

a₇≧c₁>0, a₉≧0, a₁₃≧0, a₁₁²≦4a₉a₁₃; (10)

b₇≧c₂>0, b₉≧0, b₁₃≧0, b₁₁²≦4b₉b₁₂, (11)

where c₁ and c₂ are any positive constants.

With the constraints (10)-(11), (9) becomes a constrained optimization. However, we may use the following transform to convert it into an unconstrained optimization on the parameters a′ᵢ and b′ᵢ:

$${a}_{i} = {a}_{i}^{′} , {b}_{i} = {b}_{i}^{′} , \\ if i \neq 7 , 9 , 11 , 13 , \\ {a}_{7} = {c}^{{a}_{7}^{′}} + {c}_{1} , {a}_{9} = {c}^{{a}_{9}^{′}} , {a}_{13} = {c}^{{a}_{13}^{′}} , \\ {a}_{11} = \frac{4}{π} arc tan ( {a}_{11}^{′} ) {c}^{( {a}_{9}^{′} + {a}_{13}^{′} ) / 2} ; \\ {b}_{7} = {c}^{{b}_{7}^{′}} + {c}_{2} , {b}_{9} = {c}^{{b}_{9}^{′}} , {b}_{13} = {c}^{{b}_{13}^{′}} , \\ {b}_{11} = \frac{4}{π} arc tan ( {b}_{11}^{′} ) {c}^{( {b}_{9}^{′} + {b}_{13}^{′} ) / 2} , \qquad ( 12 )$$

where c>1. Accordingly, the Gâteaux derivatives w.r.t. a′ᵢ and b′ᵢ can be computed via the chain rule:

$$\frac{DJ}{{Da}_{i}^{′}} = {\sum }_{j} \frac{\partial {a}_{j}}{\partial {a}_{i}^{′}} \frac{DJ}{{Da}_{j}} , \frac{DJ}{{Db}_{i}^{′}} = {\sum }_{j} \frac{\partial {b}_{j}}{\partial {b}_{i}^{′}} \frac{DJ}{{Db}_{j}}$$

In this section, we present the results on four different computer vision/image processing tasks: edge detection, denoising, segmentation, and object detection. For each task, we prepare 60 150×150 images and their ground truth outputs as training image pairs. We use the input images as the initial function of 0 and ρ, i.e., Oₘ|ₜ₌₀=ρₘ|ₜ₌₀=Iₘ. And the remaining parameters are chosen as: c=1.5, M=60, and λᵢ=μᵢ=10⁻⁷, i=0, 1, . . . , 14.

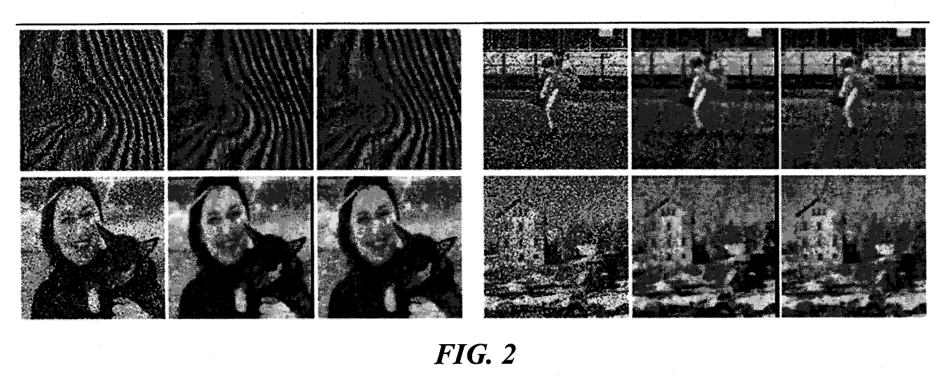

After the PDE system is learnt, we apply it to test images. Part of the results are shown in FIGS. 2-7, respectively. Note that we do not scale the range of pixel values of the output to be between 0 and 255. Rather, we clip the values to be between 0 and 255. Therefore, the reader can compare the strength of response across different images.

For image denoising task, as shown in FIG. 2, we generate input images by adding Gaussian noise to the original images and use the original images as the ground truth. One can see that our PDEs suppresses most of the noise while preserving the edges well. So we easily obtain PDEs that produce good denoising results.

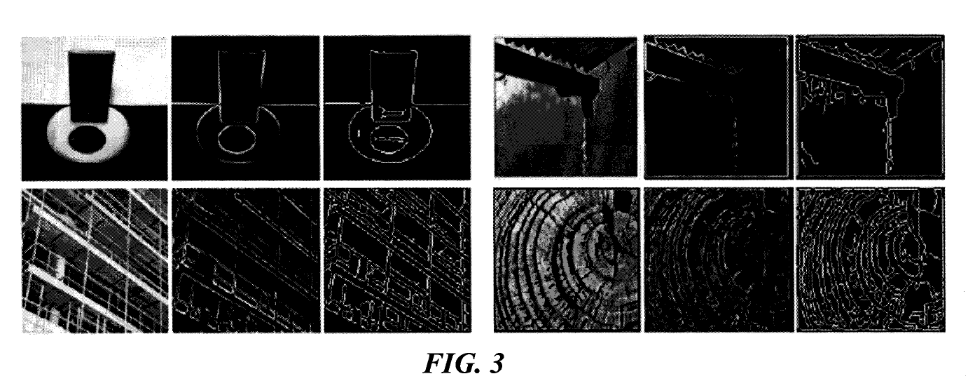

For image edge detection task (FIG. 3), we want our learnt PDE system to approximate the Canny edge detector. For each group of images, on the left is the input image, in the middle is the output of our learnt PDEs, and on the right is the edge map by the Canny detector. One can see that our PDEs detects the important edges while suppressing the minor edges. One can see that our PDEs detect the important edges while suppressing the minor edges. Note that the Canny detector involves a strongly nonlinear operation: thresholding. So it is difficult to approximate.

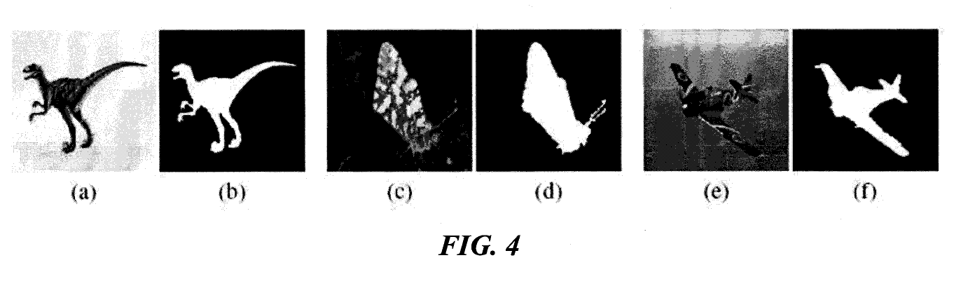

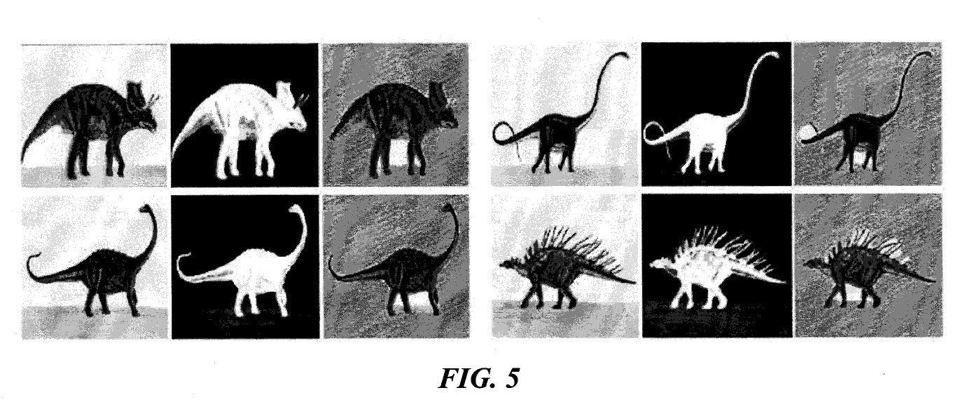

For image segmentation task, we choose the “dinosaur” data set of Corel and prepare the manually segmented masks as the outputs of the training images (FIGS. 4a-4b), where the dark regions are the background. The segmentation results are shown in FIG. 5. We see that our learnt PDEs output almost perfect object masks. We also test the active contour method. As active contour methods require the smoothness of object profile, they have difficulty in segmenting the object details, as shown in FIG. 5.

The above three tasks show that our learnt PDE system could do low-level image processing well. Next, we present the results on a much more challenging task: object detection. Namely, detect the region of object of interest and do not respond (or respond much weaker) outside the object region or if the object is absent in the image. We believe that this is a task for which human intuition is hard to apply. And we are unaware of any PDE-based method that can accomplish this task. The existing PDE-based segmentation algorithms will always output an “object region” even if the image does not contain the object of interest. We will show that using learnt PDEs, the response will be selective. For this task, we choose two data sets of Corel: butterfly and plane, and prepare the training data as did for “dinosaur” (FIGS. 4c-4f).

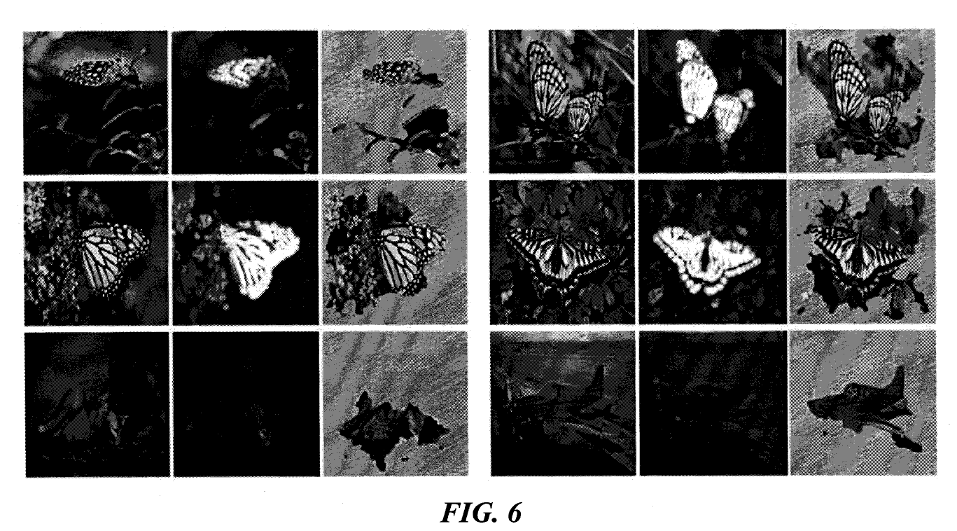

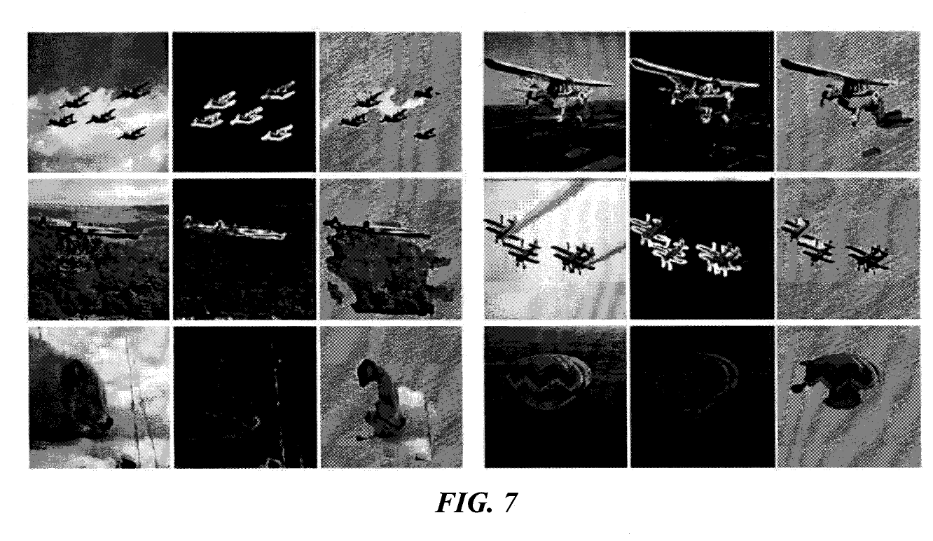

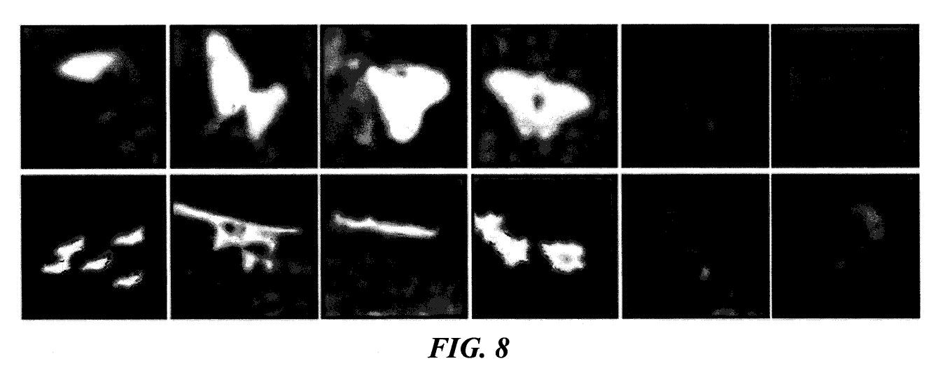

The background and foreground of the “butterfly” and “plane” data sets (FIGS. 6 and 7) are complex. So the object detection is difficult. One can see that our learnt PDEs respond strongly (the brighter, the stronger) in the regions of objects of interest, while the response in the background is relatively weak, even if the background also contains strong edges or rich textures, or has high graylevels. Note that as our learnt PDEs only approximate the desired vision task, one cannot expect that the outputs are exactly binary. Actually, without the constraints (10)-(11), the outputs can be closer to binary if blowup does not happen. See FIG. 8. In contrast, artificial PDEs mainly output the rich texture areas. We also apply the learnt object-oriented PDEs to images of other objects (the third rows of FIGS. 6 and 7). One can see that the response of our learnt PDEs is relatively low across the whole image. As clarified in paragraph [0041], we present the output images by clipping values, not scaling values, to [0, 255]. So we can compare the strength of response in different images. In comparison, the method in prior systems still outputs the rich texture regions. The above examples, though not perfect, show that our learnt PDEs are able to differentiate the object/non-object regions, without requiring the user to teach them what features are and what factors to consider.

As described above, we have presented a general framework of learning PDEs from data for specific vision tasks. The experimental results support the theory. We found that the constraints (10)-(11) may be at times a little too restrictive. Those conditions are only for ensuring that there must not be blowups when computing. However, we have also found that sometimes blowup does not happen even if we do not impose those constraints and the outputs are even better. FIG. 8 shows the outputs of the PDEs learnt without constraints on the coefficients for detecting butterflies and planes. One can see the results are significantly better than those with constraints.

FIG. 8 shows results of detecting butterflies (top) and planes (bottom), without imposing constraints (10)-(11) on the coefficients. The input images are the same as and in the same order as those in FIG. 6 and FIG. 7, respectively.

Following the theories presented between paragraph [0022] and [0028], we can find that the adjoint equation for φₘ is:

$$\{ \frac{\partial {ϕ}_{m}}{\partial t} + {\sum }_{p ∈ 𝓅} {( - 1 )}^{\vert p \vert} {( {σ}_{O ; p} {ϕ}_{m} + {σ}_{ρ ; p} {φ}_{m} )}_{p} = 0 , ( x , t ) ∈ Q , \\ {ϕ}_{m} = 0 , ( x , t ) ∈ Γ , \\ {ϕ}_{m} {\vert}_{t = 1} = {\tilde{O}}_{m} - {O}_{m} ( 1 ) , x ∈ Ω , \qquad ( 13 )$$

where σ_{O;p} and σ_{ρ;p} are the coefficients of

$$\frac{{\partial }^{\vert ρ \vert}}{\partial p}$$

in the differential operator [symbol] and [symbol] , respectively, i.e.,

$${σ}_{O ; p} = \frac{\partial {L}_{O}}{\partial {O}_{p}} = {\sum }_{i = 0}^{16} {a}_{i} \frac{\partial {inv}_{i} ( ρ , O )}{\partial {O}_{p}} , \\ {σ}_{ρ ; p} = \frac{\partial {L}_{ρ}}{\partial {O}_{p}} = {\sum }_{i = 0}^{16} {b}_{i} \frac{\partial {inv}_{i} ( O , ρ )}{\partial {O}_{p}} , \\ where \\ \{ \frac{\partial {ϕ}_{m}}{\partial t} + {\sum }_{p ∈ 𝓅} {( - 1 )}^{\vert p \vert} {( {\tilde{σ}}_{O ; p} {ϕ}_{m} + {\tilde{σ}}_{ρ ; p} {φ}_{m} )}_{p} = 0 , ( x , t ) ∈ Q , \\ {φ}_{m} = 0 , ( x , t ) ∈ Γ , \\ {φ}_{m} {\vert}_{t = 1} = 0 , x ∈ Ω , \qquad ( 14 )$$

Then the Gâteaux derivative of J w.r.t. the coefficients are respectively:

$$\frac{DJ}{{Da}_{i}} = {λ}_{i} {a}_{i} - {\int }_{Ω} {\sum }_{m = 1}^{M} {ϕ}_{m} {inv}_{i} ( {ρ}_{m} , {O}_{m} ) d Ω , \\ \frac{DJ}{{Db}_{i}} = {μ}_{i} {b}_{i} - {\int }_{Ω} {\sum }_{m = 1}^{M} {φ}_{m} {inv}_{i} ( {O}_{m} , {ρ}_{m} ) d Ω . \qquad ( 15 )$$

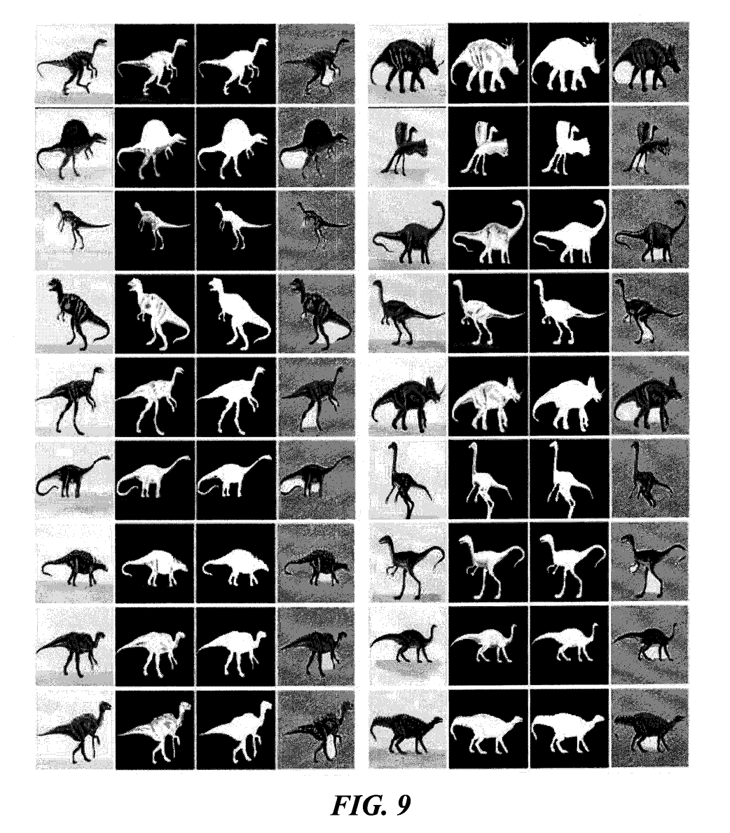

FIG. 9 illustrates more results of segmenting dinosaurs. For each group of images, on the left is the input image, in the middle are the output mask map and the converted binary mask (we simply threshold at 127) of the learnt PDEs. The right side is the segmentation result of prior art technologies.

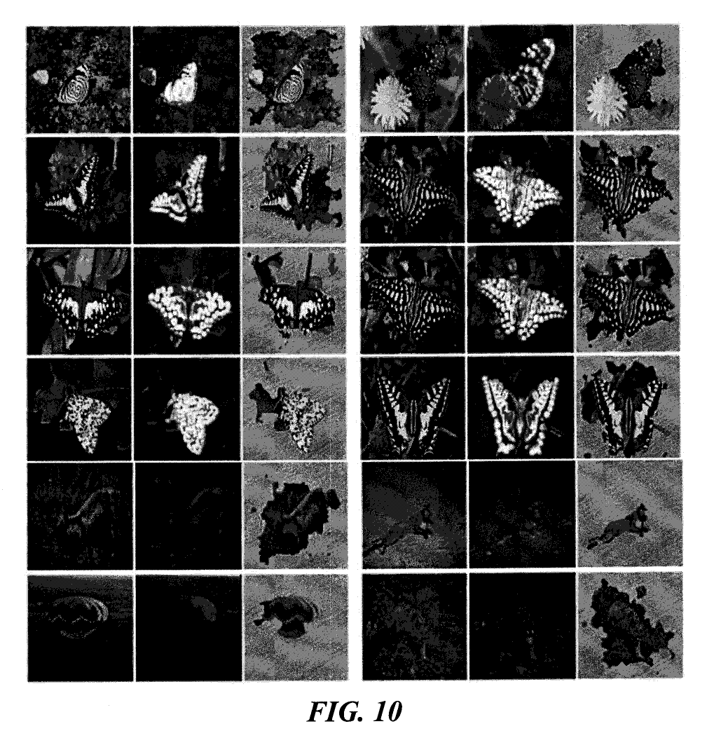

FIG. 10 illustrates more results of detecting butterflies. For each group of images, on the left is the input image, in the middle is the output mask map of our learnt PDEs, and on the right is the segmentation result of prior art technologies. The fifth and sixth rows are the detection results on images that do not contain butterflies.

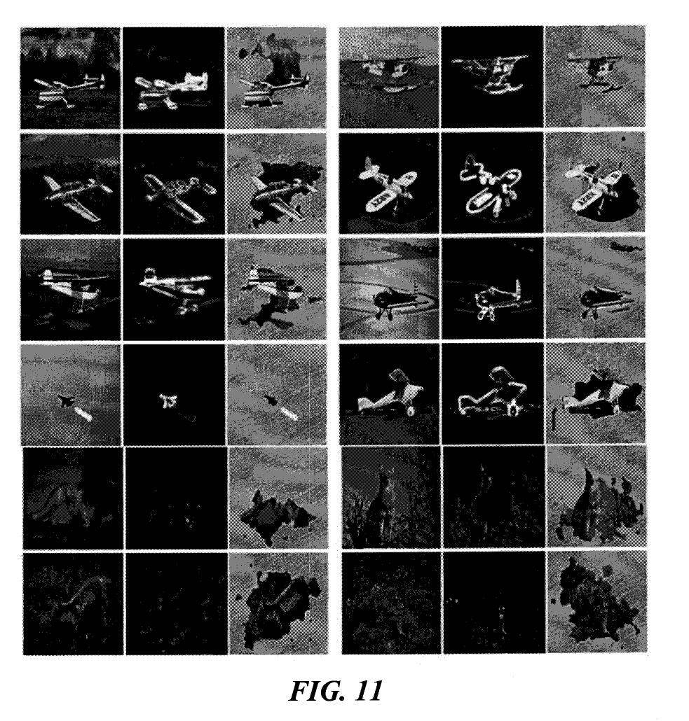

FIG. 11 illustrates more results of detecting planes. For each group of images, on the left is the input image, in the middle is the output mask map of our learnt PDEs, and on the right is the segmentation result of prior art technologies. The fifth and sixth rows are the detection results on images that do not contain planes. Please be reminded that the responses may appear stronger than they really are, due to the contrast with the dark background.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. Accordingly, the invention is not limited except as by the appended claims.

I/We claim:

1. A method for processing image, the method comprising:
obtaining image data for processing;
obtaining training data, wherein the training data includes image samples;
obtaining ground truth data;
selecting a basis for differential operators;
defining an objective functional, wherein the definition of the objective functional utilizes the ground truth data and data related to the differential operators;
computing the optimal control functions based on the objective functional; and
processing the optimal control functions to merge the basis differential operators into the output differential operators.

2. The method of claim 1, wherein the method further comprises the step of utilizing the output differential operators for edge detection in an image of the image data.

3. The method of claim 1, wherein the method further comprises the step of utilizing the output differential operators for denoising an image in the image data.

4. The method of claim 3, wherein input images are created by adding Gaussian noise to the image data, and using the original image data as the ground truth data.

5. The method of claim 1, wherein the method further comprises the step of utilizing the output differential operators for segmentation of an image in the image data.

6. The method of claim 1, wherein the method further comprises the step of utilizing the output differential operators for object detection applied to an image in the image data.

7. A system for processing image, the system comprising:
a component for obtaining image data for processing;
a component for obtaining training data, wherein the training data includes image samples;
a component for obtaining ground truth data;
a component for selecting a basis for differential operators;
a component for defining an objective functional, wherein the definition of the objective functional utilizes the ground truth data and the output related to the differential operators;
a component for computing optimal control functions based on the objective functional; and
a component for processing the optimal control functions to merge the basis differential operators into the output differential operators.

8. The system of claim 7, wherein the system further comprises a component for utilizing the output differential operators for edge detection in an image of the image data.

9. The system of claim 7, wherein the system further comprises a component for utilizing the output differential operators for denoising an image in the image data.

10. The system of claim 9, wherein input images are created by adding Gaussian noise to the image data, and using the original image data as the ground truth data.

11. The system of claim 7, wherein the system further comprises a component for utilizing the output differential operators for segmentation of an image in the image data.

12. The system of claim 7, wherein the system further comprises a component for utilizing the output differential operators for object detection applied to an image in the image data.

13. The system of claim 7, wherein the system processes the training data in accordance with an objective functional:
$$J ( {\{ {O}_{m} \}}_{m = 1}^{M} , {\{ {a}_{j} \}}_{j = 0}^{16} , {\{ {b}_{j} \}}_{j = 0}^{16} ) = \frac{1}{2} {\sum }_{m = 1}^{M} {\int }_{Ω} {[ {O}_{m} ( x , 1 ) - {\tilde{O}}_{m} ( x ) ]}^{2} d Ω + \frac{1}{2} {\sum }_{j = 0}^{16} {λ}_{j} {\int }_{0}^{1} {a}_{j}^{2} ( t ) d t + \frac{1}{2} {\sum }_{j = 0}^{16} {μ}_{j} {\int }_{0}^{1} {b}_{j}^{2} ( t ) d t ,$$

14. A computer-readable storage media comprising computer executable instructions to, upon execution, processes image data, the process including the steps of:
obtaining image data;
obtaining training data, wherein the training data includes image samples;
obtaining ground truth data;
selecting a basis for differential operators;
defining an objective functional, wherein the definition of the objective functional utilizes the ground truth data and data related to the differential operators;
computing optimal control functions based on the objective functional; and
processing the optimal control functions to merge the basis differential operators into the output differential operators.

15. The computer-readable storage media of claim 14, wherein the process further comprises the step of utilizing the output differential operators for edge detection in an image of the image data.

16. The computer-readable storage media of claim 14, wherein the process further comprises the step of utilizing the output differential operators for denoising an image in the image data.

17. The computer-readable storage media of claim 16, wherein input images are created by adding Gaussian noise to the image data, and using the original image data as the ground truth data.

18. The computer-readable storage media of claim 14, wherein the process further comprises the step of utilizing the output differential operators for segmentation of an image in the image data.

19. The computer-readable storage media of claim 14, wherein the process further comprises the step of utilizing the output differential operators for object detection applied to an image in the image data.

20. A system for processing image, the system comprising:
a component for obtaining image data for processing;
a component for obtaining training data, wherein the training data includes image samples and wherein the training data is in accordance with an objective functional:
$$J ( {\{ {O}_{m} \}}_{m = 1}^{M} , {\{ {a}_{j} \}}_{j = 0}^{16} , {\{ {b}_{j} \}}_{j = 0}^{16} ) = \frac{1}{2} {\sum }_{m = 1}^{M} {\int }_{Ω} {[ {O}_{m} ( x , 1 ) - {\tilde{O}}_{m} ( x ) ]}^{2} d Ω + \frac{1}{2} {\sum }_{j = 0}^{16} {λ}_{j} {\int }_{0}^{1} {a}_{j}^{2} ( t ) d t + \frac{1}{2} {\sum }_{j = 0}^{16} {μ}_{j} {\int }_{0}^{1} {b}_{j}^{2} ( t ) d t ,$$
a component for obtaining ground truth data;
a component for selecting a basis for differential operators;
a component for defining an objective functional, wherein the definition of the objective functional utilizes the ground truth data and data related to the differential operators;
a component for computing optimal control functions based on the objective functional; and
a component for processing the optimal control functions to merge the basis differential operators into the output differential operators,
wherein the system further comprises a component for utilizing the output differential operators for edge detection in an image of the image data,
wherein the system further comprises a component for utilizing the output differential operators for denoising an image in the image data.
